(19) United States
(12) Patent Application Publication
(10) Pub. No.: US 2015/0279371 A1
(43) Pub. Date: Oct. 1, 2015

(54) System and Method for Providing an Audio Interface for a Tablet Computer

(71) Applicant: Fuhu, Inc., El Segundo, CA (US)

(72) Inventor: Robb Fujioka, Manhattan Beach, CA (US)

(73) Assignee: Fuhu, Inc., El Segundo, CA (US)

(21) Appl. No.: 14/669,698

(22) Filed: Mar. 26, 2015

Related U.S. Application Data
(60) Provisional application No. 61/970,426, filed on Mar. 26, 2014.
(60) Provisional application No. 62/080,857, filed on Nov. 17, 2014.

(51) Int. Cl. G10L 17/22

(52) U.S. Cl. CPC G10L 17/22

(57) ABSTRACT

A system and method for providing an audio interface for an apparatus is disclosed. According to one embodiment, the apparatus includes a processor, a voice output module adapted to transmit an audio query according to an application program, a voice input module adapted to receive a vocal signal in response to the audio query, and a display adapted to display a content item associated with the audio query. The processor is adapted to run an operating system in multi-operating environments including a first operating environment for a first user and a second operating environment for a second user. The application program determines whether the vocal signal contains a correct response to the audio query. The application program is configured to run in the first operating environment while the operating system performs a background operation.

### CROSS REFERENCES

This application claims the benefit of and priority to U.S. Provisional Application Nos. 61/970,426, filed on Mar. 26, 2014 and 62/080,857, filed on Nov. 17, 2014, entitled “Interface for Virtual Devices, Systems and Methods,” the disclosures of which are hereby incorporated by reference in their entirety.

### FIELD

The present disclosure relates to interfaces for computers, more particularly, to audio interfaces for providing voice recognition for tablet computers.

### BACKGROUND

Various mobile devices such as smartphones, laptop computers, and tablet computers are compatible with mobile gaming applications. Users typically control games by providing various user inputs such as a touch on a touch screen, a push of a button, and tilting a mobile device. For example, Temple Run 2® is a mobile gaming application that involves characters that perform running, jumping, turning, and sliding. The characters navigate perilous cliffs, zip lines, mines, and forests and try to escape with a cursed idol. In another example, Cut the Rope® is a mobile physics-based puzzle gaming application that involves cutting a rope to feed candy to a little monster character. When a mysterious package arrives, the little monster character requests candy, and the player collects gold stars, discovers hidden prizes, and unlocks new gaming levels. Yet another example of a gaming application is Triple Town®, a puzzle game in which the player tries to grow the greatest possible city. Points are scored as a function of the city size built, for example, by matching three or more game-pieces, combining grass to form a bush, and combing three bushes to make a tree, until the player has filled the board with houses, cathedrals and castles. Giant bear characters try to obstruct the player's progress.

Recent advances in voice recognition technology allowed for application developers to develop applications that allow users to communicate with their mobile device by voice. For example, APPLE's SIRI® or GOOGLE NOW® allows a user to make calls, send messages, play music, launch applications, make reservations, find locations, buy movie tickets, and hail a cab by dictating instructions or receive information by asking questions to a voice recognition application in natural language. The users generally launch the voice recognition application by pressing a button on a mobile device or selecting the voice recognition application from the menu.

### SUMMARY

A system and method for providing an audio interface for an apparatus is disclosed. According to one embodiment, the apparatus includes a processor, a voice output module adapted to transmit an audio query according to an application program, a voice input module adapted to receive a vocal signal in response to the audio query, and a display adapted to display a content item associated with the audio query. The processor is adapted to run an operating system in multi-operating environments including a first operating environment for a first user and a second operating environment for a second user. The application program determines whether the vocal signal contains a correct response to the audio query. The application program is configured to run in the first operating environment while the operating system performs a background operation.

Various embodiments may incorporate one or more of these and other features described herein while remaining within the spirit and scope of the present disclosure. Further features of the system or method for providing an audio interface, its nature, and various advantages and embodiments will be more apparent by reference to the accompanying drawings and the following detailed description.

### BRIEF DESCRIPTION OF THE DRAWING

In order to describe the manner in which the above recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates a front view of an exemplary computing system, according to one embodiment;

FIG. 2 illustrates a side view of the exemplary computing system shown in FIG. 1, according to one embodiment;

FIG. 3 illustrates an exemplary transition screen displayed on a display of a computing device, according to one embodiment;

FIG. 4 illustrates an exemplary transition screen displayed on a display of a computing device, according to another embodiment;

FIG. 5 illustrates an exemplary query screen displayed on a display of a computing device, according to one embodiment;

FIG. 6 illustrates a screen displayed in response to a user's answer to the query of FIG. 5, according to one embodiment;

FIG. 7 illustrates another exemplary query screen displayed on a display of a computing device, according to one embodiment;

FIG. 8 illustrates a screen displayed in response to a user's answer to the query of FIG. 7, according to one embodiment;

FIG. 9 is a flowchart for providing an audio interface, according to one embodiment;

FIG. 10 is a flowchart for providing an audio interface, according to another embodiment;

FIG. 11 illustrates an exemplary computer architecture that may be used for the present system, according to one embodiment; and

FIG. 12 illustrates a schematic diagram of an exemplary tablet computer, according to one embodiment.

While the present disclosure is subject to various modifications and alternative forms, specific embodiments thereof have been shown by way of example in the drawings and will herein be described in detail. The present disclosure should be understood to not be limited to the particular forms disclosed, but on the contrary, the intention is to cover all modifications, equivalents, and alternatives falling within the spirit and scope of the present disclosure.

### DETAILED DESCRIPTION

A system and method for providing an audio interface for an apparatus is disclosed. According to one embodiment, the apparatus includes a processor, a voice output module adapted to transmit an audio query according to an application program, a voice input module adapted to receive a vocal signal in response to the audio query, and a display adapted to display a content item associated with the audio query. The processor is adapted to run an operating system in multi-operating environments including a first operating environment for a first user and a second operating environment for a second user. The application program determines whether the vocal signal contains a correct response to the audio query. The application program is configured to run in the first operating environment while the operating system performs a background operation.

In the following description, numerous specific details have been set forth to provide a more thorough understanding of some embodiments of the present disclosure. However, it will be appreciated by those skilled in the art that embodiments of the present disclosure may be practiced without such specific details or with different implementations for such details. Additionally some well-known structures have not been shown in detail to avoid unnecessarily obscuring the present disclosure.

According to one embodiment, an audio interface includes a speaker adapted to communicate with a processor, the speaker adapted to transmit an audio query, and a voice recognition process adapted to communicate with the processor. The voice recognition process is adapted to receive the vocal signal in response to the audio query. The processor is operable by a set of executable instructions storable in a non-transitory medium, and the set of executable instructions configurable for determining whether the vocal signal contains a correct response to the audio query.

More specifically, the present disclosure involves an audio interface for a tablet computer, wherein the audio interface is preinstalled on the tablet computer. Alternatively, the audio interface is later downloaded from the Internet as a mobile application program (mobile app) or installed by way of a removable recording medium such as a USB drive or a CD ROM. The audio interface may utilize user environments for a given operating system and a given plurality of application programs.

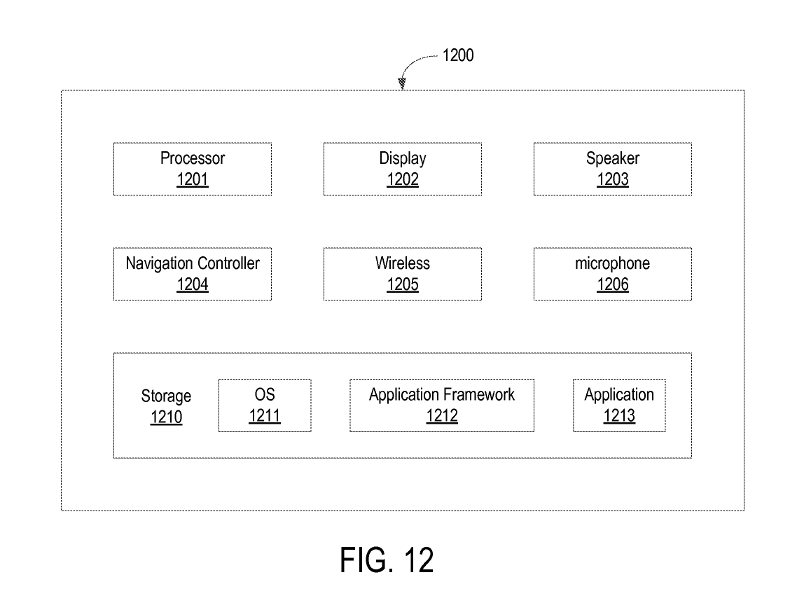

FIG. 12 illustrates a schematic diagram of an exemplary tablet computer, according to one embodiment. A tablet computer 1200 includes a processor 1201, a display screen 1202, a voice output module (e.g., a loudspeaker 1203), a voice input module (e.g., a microphone 1206), a navigation controller 1204, a wireless data communication interface 1205, and a non-transitory machine-readable storage medium 1210 that stores the set of executable instructions. When executed by the processor 1201, the set of executable instructions causes the tablet computer 1200 to perform operations according to the set of executable instructions. An operating system 1211, stored, at least in part, in relation to the non-transitory machine-readable storage medium, includes an application framework layer 1212 and an application layer 1213, as well as instructions that enable an end-user to interact with the operating system 1211 via the navigation controller 1204. The operating system 1211 further includes a system control feature, a success-rate monitoring feature, an integrated adaptive learning system, and a content management feature.

According to one embodiment, the operating system 1211 is configured to run an overlay system to be executed the processor 1201. The overlay system may maintain the audio interface that includes the set of executable instructions for providing queries, receiving vocal responses, displaying images relating to the queries, processing and categorizing the vocal responses, and providing the visual and audible feedback via the application layer. The adaptive learning system portion of the overlay system includes a set of instructions for selecting audio queries for a specific user (e.g., a child). The adaptive learning system selects the audio queries that includes binary questions and/or multiple-choice questions (audibly and optionally visually indicated) related to direct instructional content suitable for the user. The audio interface may also include a configuration and evaluation process that provides instructions for executing indirect instructional content. The indirect instructional content may include reinforcement content for encouraging learning information in a plurality of subject matter areas, such as academic subject matter areas or cognitive skills, as well as a set of instructions for executing at least one technological enabler to support the direct instructional content and the indirect instructional content.

According to one embodiment, the operating system of the tablet computer is further provided with at least two different user interfaces, whereby each user interface is customized based on a specific type or profile of the end-user. Each type of user interface is different in visual appearance and in workflow. For example, a child-friendly user interface permits access to applications, Web content, and games that are previously identified or previously uploaded as being appropriate for a target age or gender group. The end-user earns virtual currency or other virtual rewards by performing activities on the tablet computer, spends the virtual currency or other virtual rewards in an application store suitable for the target age or gender group, thereby improving educational skills through core-curriculum, or state-standardized lessons. Meanwhile, a supervisory user interface provides a default operating system environment that allows unrestricted access to all application programs and content, provides access to settings of the tablet computer, allows access to controls for the other user interfaces. The supervisory interface enables monitoring time and usage of content in the other user interfaces by viewing reports and analytics, such as reports related to the success rate of the child in learning the content via the feedback data. The supervisory user interface facilitates arranging content and uploading or downloading content for the other user interfaces by way of a series of toggle switches or other similar controls.

The overlay system includes an access control configured to permit or deny a request for access in the second operating environment to resources and/or data. In one embodiment, the overlay system is executed in the application framework layer 1212 of the operating system 1211 and includes a hypervisor that provides an operating platform for a first user interface, a second user interface, and an application space that provides access to the application layer 1211. The hypervisor runs multiple operating systems on the tablet computer and separates the individual kernels of each operating system from the hardware of the tablet computer, controlling which computer hardware resources are available to each operating system at any given time. A hypervisor effectively creates multiple virtual machines from the tablet computer, such that each operating system sees a separate virtual machine. Therefore, multiple operating systems running on the tablet computer through the hypervisor are not running on a shared kernel. The hypervisor adds system overhead due to each operating system having to access system resources through virtualization in the hypervisor. Additionally, because the hypervisor allocates the processor and other computing resources of the tablet computer, each operating system may not be able to effectively schedule processes and tasks.

In another exemplary embodiment, the overlay system further includes instructions for providing a first operating environment associated with the first user interface. In another exemplary embodiment, the overlay system is configured to be activated when the tablet computer is powered, and disabled when the tablet computer is in a dormant state for a predetermined period of time. In another exemplary embodiment, the overlay system further includes a set of instructions for providing a time monitoring interface that communicates to the end-user the amount of time the tablet computer has had continuous activity thereon and how much total time has been consumed utilizing the tablet computer. In another exemplary embodiment, a time management interface and a sleep control interface are configurable by way of a remote content source using the wireless data communication interface.

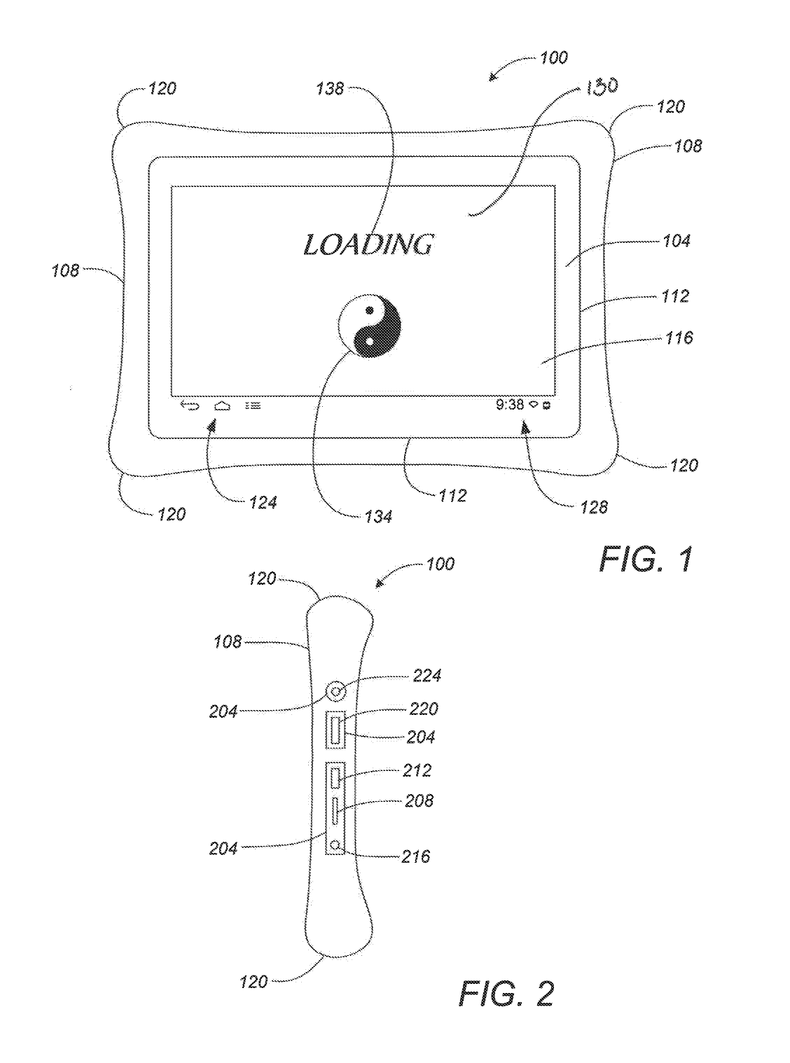

FIG. 1 illustrates a front view of an exemplary computing system, according to one embodiment. The computing system 100 includes a computing device 104, such as a tablet computer, having a touch screen display 116. The audio interface shown on the touch screen display 116 is adapted to educate a user by providing audible queries, receiving vocal responses to the audible queries, and providing visual and audible feedback in relation to the vocal responses. In one embodiment, the operating system of the computing device 104 launches a mobile application program corresponding to a set of executable instructions, as shown by a symbolic descriptor 134 renderable on the touch screen display 116. In one embodiment, the operating system of the computing device launches the mobile application program while running a background operation (e.g., evaluating and monitoring a user's activity and interfaces with the computing device 104) or during an idle time when a different application program is concurrently running.

The computing system 100 further includes an impact resistant protector 108 that retains the computing device 104. The protector 108 is made of a flexible or elastic material disposable in relation to the computing device 104 by an end-user to protect the computing device 104 from impacts, for example, due to dropping or collision with other objects. The protector 108 has an opening 112 for facilitating viewing and interaction with the touch screen display 116 of the computing device 104. Corner regions 120 of the protector 108 prevent the computing device 104 from lying flat on a horizontal surface, such as a table top or a desk, for facilitating air-cooling or ventilation of the computing device 104. The corner regions 120 also provide additional protection to corners of the computing device 104 that are vulnerable to damage when the computing device 104 is dropped or impacted.

The touch screen display 116 preferably enables the end-user to view and interact with information thereon displayed. In one embodiment, the touch screen display 116 is a capacitive display that is operable in relation to the computing device 104 by touching the touch screen display 116 with an object, such as a finger. In another embodiment, the touch screen display 116 is operable in relation to the computing device 104 by touching the touch screen display 116 with a stylus or other similar implement.

The computing device 104 further includes internal hardware, as well as suitable firmware, that supports the functionality of the touch screen display 116. The computing device 104 further includes at least one navigation controller 124 and at least one status indicator 128. The navigation controller 124 facilitates operating the computing device 104 by a user (e.g., a child), in addition to software controls displayable on the touch screen display 116. The at least one navigation controller 124 includes, but is not limited to, a back button, a home button, and a shortcut menu button. The at least one status indicator 128 includes, but is not limited to, a clock, a Wi-Fi signal strength indicator, and a recycle bin or trash can icon. A wide variety of symbols and functions are encompassed by the present disclosure and are used for, or associated with, the at least one navigation controller 124 and the at least one status indicator 128.

According to one embodiment, the touch screen display 116 displays a transition screen 130 including a symbolic descriptor 134 and a text descriptor 138. The computing device 104 includes software for rendering a plurality of transition screens 130 on the touch screen display 116 at predetermined times and for predetermined durations to entertain or interest the end-user while the computing device 104 performs other operations. In one embodiment, the plurality of transition screens 130 includes a software portion of the operating system of the computing device 104.

The plurality of transition screens 130 include a software program that is installed by either an end-user or a manufacturer of the computing device 104, in addition to the operating system of the computing device 104. In one embodiment, the plurality of transition screens 130 are implemented as at least a portion of an internal hardware configuration of the computing device 104. Moreover, the implementation of the plurality of transition screens 130 includes an option for disabling the display of the plurality of transition screens 130. Disabling the plurality of transition screens 130 may be manually controlled by the end-user, or by the system to prevent the plurality of transition screens 130 from interfering with other software programs and operations, or to prevent the plurality of transition screens 130 from displaying during times when demand for resources is high that would otherwise lead to delays or hesitations in the performance of the computing device 104. A wide variety of transition screens 130 may be implemented with the computing device 104 by way of various techniques.

In addition to being interesting to a user, the transition screens 130 are also contextual and convey information to the user about a background operation being performed by the computing device 104 during the time a given transition screen 130 is displayed. For example, the transition screen 130 indicates that either the operating system of the computing device 104 or a software program that is stored on the computing device 104 is loading into a memory of the computing device 104. In this case, the text descriptor 138 displays indicia, such as the word LOADING, and the symbolic descriptor 134 that corresponds to LOADING is displayed on the touch screen display 116. In another embodiment, the text descriptor 138 displays a farewell, such as, by way of example, the term GOOD BYE, when the operating system is shutting down and the computing device 104 is preparing to turn off. A wide variety of other suitable words or sentences for the text descriptor 138 can be displayed in conjunction with the symbolic descriptor 134 without deviating from the scope of the present disclosure.

According to one embodiment, the symbolic descriptor 134 includes a still image that is relevant to a background operation that the computing device 104 performs. Examples of the symbolic descriptor 134 include, but are not limited to, a logo, an image of a popular sports personality, a picture of a famous movie star, a cartoon character, or any other similar image suitable for displaying on the transition screen 130. According to one embodiment, the symbolic descriptor 134 and the text descriptor 138 share a common theme. For example, the symbolic descriptor 134 includes a cartoon character, and the text descriptor 138 includes popular slogans or comments that are associated with the cartoon character. In another example, the symbolic descriptor 134 is a movie actor, and the text descriptor 138 is a quote associated with the movie actor. A wide variety of context-based transition screens 130 including the symbolic descriptor 134 and the text descriptor 138 may be utilized with the computing device 104.

FIG. 2 illustrates a side view of the exemplary computing system shown in FIG. 1, according to one embodiment. The protector 108 includes at least one opening 204 that provides access to port 224 and slots 220 on the exterior side of the computing device 104. Each opening 204 is shaped and sized to match a corresponding port 224 or slot 220 of the computing device 104. Markings, such as indicia, may be applied to an exterior surface of the protector 108 to indicate functions of each port 224 or slot 220 within the openings 204. The openings 204 advantageously facilitate coupling of memory cards (not shown), plugs to peripheral devices (not shown), a tip of a stylus (not shown), and other similar devices or accessories (not shown) with the computing device 104.

According to one embodiment, the computing device 104 includes a card slot 208 suitably configured to receive an external storage card (not shown). In one embodiment, the card slot 208 is configured to receive a removable memory card, such as a Micro Secure Digital (Micro SD) storage card. In another embodiment, the card slot 208 and the internal firmware are configured to receive a Micro SD card. The firmware and the card slot 208 are configured to operate with other similar types of external storage cards without deviating from the scope of the present disclosure.

The computing device 104 further includes a Micro Universal Serial Bus (USB) port 212 that is suitably configured to enable an end-user to connect the computing device 104 to an external computer by way of a USB cable. In one embodiment, the Micro USB port 212 enables an end-user to install software applications from the computing device 104 onto the external computer. In another embodiment, the Micro USB port 212 enables transferring photographs and video data files from the Micro SD card to the external computer. Moreover, the Micro USB port 212 enables the computing device 104 to be powered by the external computer by way of the USB cable. The Micro USB port 212 enables is further utilized for charging an internal battery of the computing device 104 from an external computer or a power adapter that receives electrical power from a power outlet.

The computing device 104 further includes a power adapter port 216 suitably configured to receive a power adapter cord (not shown) that receives electrical power from a power outlet. In one embodiment, the power adapter port 216 is configured to receive direct current (DC) at 5.0 volts (V) from the power adapter. In another embodiment, the power adapter is configured to receive alternating current (AC) in a range of approximately 100V to approximately 240V from the power outlet.

According to one embodiment, the computing device 104 includes a mini High-Definition Multimedia Interface (HDMI) port 220. The mini HDMI port 220 enables an end-user to connect the computing device 104 to an external digital video device, such as a digital camera, a camcorder, and other similar digital devices that have mini-HDMI connectors. The computing device 104 is installed with internal firmware that supports connecting with the external digital video device, as well as working with photograph and video/audio data files. The data files are formatted into popular file formats, such as, by of example, JPEG format for photograph files and MPEG-4 Part 14 (MP4) for video files. Digital audio data files may be formatted as MPEG-1, MPEG-2 Audio Layer III (MP3), or Advanced Audio Coding (AAC) format. In another embodiment, the firmware supports a video compression standard, for example, H.263 or H.264 video. A wide variety of photograph and audio/video standards may be implemented without deviating from the scope of the present disclosure.

According to one embodiment, the computing device 104 further includes a headphone jack 224 that enables an end-user to plug in external headphone speakers (not shown). When external headphone speakers are plugged into the headphone jack 224, audible sounds that are otherwise played by way of the loudspeakers (not shown) within the computing device 104 are instead played by the external headphone speakers. In an embodiment, the computing device 104 includes loudspeakers (not shown), and the loudspeakers of the computing device 104 are disabled when the external headphone speakers are plugged into the headphone jack 224. In one embodiment, the headphone jack 224 includes a 3.5-mm standard audio jack. In another embodiment, the headphone jack 224 is configured for use with external loudspeakers that are larger and/or more powerful than the loudspeakers of the computing device 104. A wide variety of uses, configurations, and alternative forms of the headphone jack 224 will be apparent to those skilled in the art without deviating from the scope of the present disclosure.

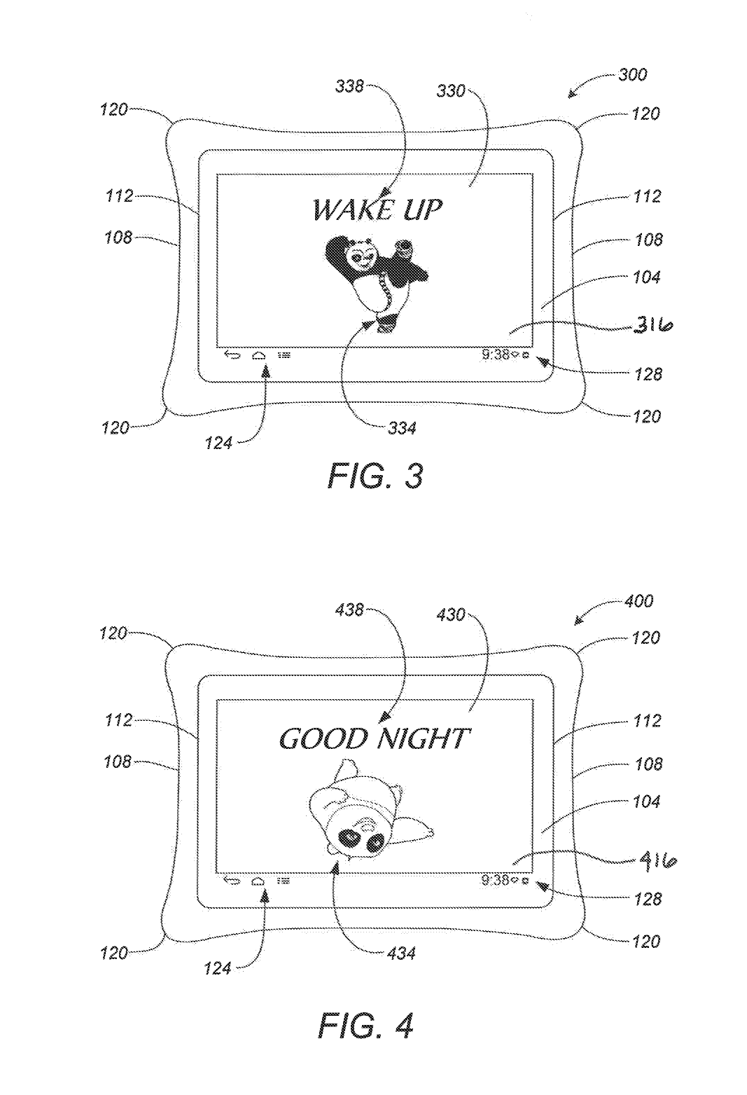

FIG. 3 illustrates an exemplary transition screen displayed on a display of a computing device, according to one embodiment. The symbolic descriptor 334 includes an animated sequence that conveys interesting information to an end-user about a background operation that the computing device 104 performs. The computing system 300 is intended for children of a specific age group. The computing system 300 includes a touch screen display 316 that displays a transition screen 330 that includes a symbolic descriptor 334 and a text descriptor 338. The symbolic descriptor 334 includes an animated sequence of a popular cartoon character performing a skit. The text descriptor 338 includes relevant words to accompany the symbolic descriptor 334. In another embodiment, the text descriptor 338 is animated in addition to the symbolic descriptor 334. For instance, the text descriptor 338 moves around on the transition screen 330 according to the animated sequence including the symbolic descriptor 334.

In other embodiments, the letters of the text descriptor 338 change size, shape, color, order, orientation, or other similar attributes, according to the animation including the symbolic descriptor 334. An animated cartoon character and animated text maintains the interest of a child user of the computing device 104 during an otherwise boring period during which the computing system 300 performs a background operation. The transition screens 330 are not limited to conveying information about background operations of the computing device 104. Rather, the transition screens 330 may be used with programs other than the operating system. For example, an alarm clock program displays the symbolic descriptor 334 in the form of an animated character arising from sleep, and the text descriptor 338 displays WAKE UP, while an alarm is sounded by the loudspeakers of the computing device 104.

FIG. 4 illustrates an exemplary transition screen displayed on a display of a computing device, according to another embodiment. The computing system 400 is targeted for children of a specific age group. The computing system 400 includes a touch screen display 416 for rendering a transition screen 430 including a symbolic descriptor 434 and a text descriptor 438. In the illustrated embodiment, the symbolic descriptor 434 displays a popular cartoon character lying down, and the text descriptor 438 displays the words, GOOD NIGHT. The symbolic descriptor 434 and the text descriptor 438 share a common theme, both conveying a message to children that now is the time for sleep. As discussed above, the symbolic descriptor 434 and the text descriptor 438 may be animated sequences.

In addition to the animations, envisioned is that the computing system 400 also plays audio soundtracks that share the common theme with the symbolic descriptor 434 and the text descriptor 438. For instance, a loudspeaker of the computing system 400 may say the words, GOOD NIGHT at the same time that those words are displayed by the text descriptor 438. In another embodiment, the symbolic descriptor 434 and the loudspeaker are synchronized such that the animated cartoon character appears to be saying the words played over the loudspeaker. An unlimited variety of audio/video content that may be suitably used with the transition screen 430.

Referring to FIGS. 1-4, the software used to facilitate the transition screens 130, 330, 430 may be embodied onto a non-transitory machine-readable medium. A machine-readable medium includes any mechanism that stores information in a form readable by a machine, e.g., a computer. For example, a machine-readable medium includes read only memory (ROM); random access memory (RAM); magnetic disk storage media; optical storage media; flash memory devices; Digital Video Disc (DVD's), EPROMs, EEPROMs, FLASH memory, magnetic or optical cards, or any type of media suitable for storing electronic instructions.

While some specific embodiments of the present disclosure have been shown, the disclosure is not to be limited to these embodiments. For example, most functions performed by electronic hardware components may be duplicated by software emulation. Thus, a software program written to accomplish those same functions may emulate the functionality of the hardware components in input-output circuitry. The present disclosure is to be understood as not being limited by the specific embodiments described herein.

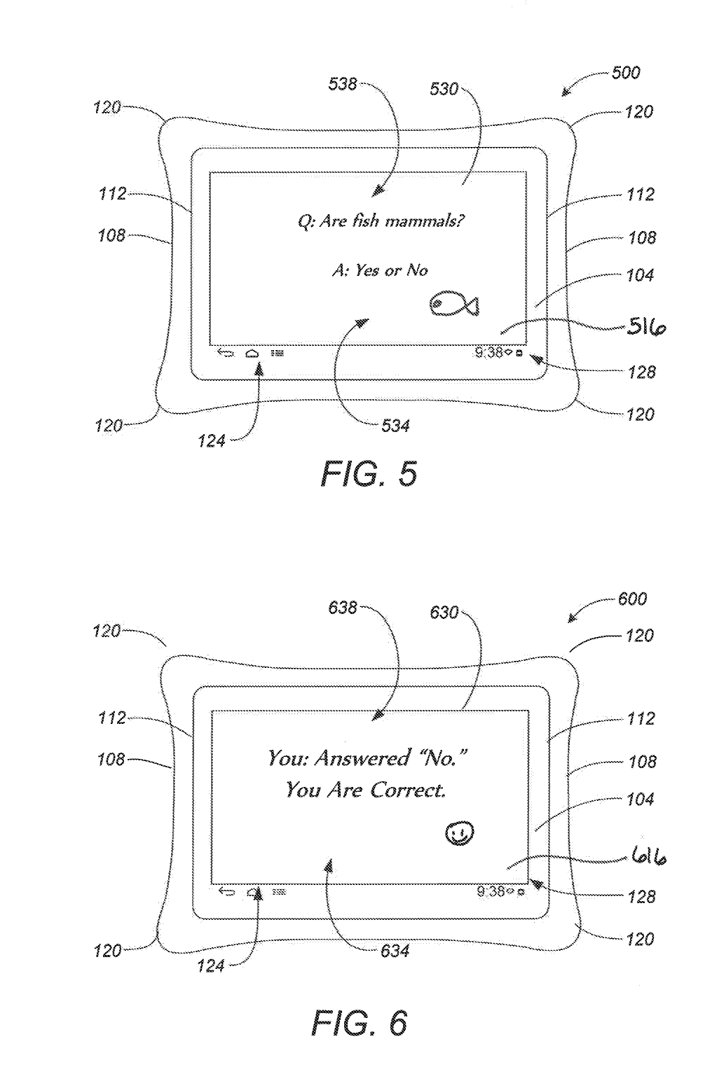

FIG. 5 illustrates an exemplary query screen displayed on a display of a computing device, according to one embodiment. The text descriptor 538 includes at least one query, such as a binary question (e.g., Q: Are fish mammals?), and optional text indicating that the appropriate response to the binary question is a yes or a no answer (e.g., A: YES or NO). The symbolic descriptor 534 includes at least one of an image of the object, such as an image of a fish, and an image relating to remaining portions of the query, corresponding to the query that conveys visual information to the end-user (e.g., a child). The symbolic descriptor 534 is used for reinforcing recognition and understanding of the object (e.g., fish) of the query such as the written word and the audible word, in relation to remaining portions (mammals) of the query.

The computing system 500 is intended for children of a specific age group. The computing system 500 includes a touch screen display 516 displaying a transition screen 530 that includes a symbolic descriptor 534 and a text descriptor 538. The symbolic descriptor 534 optionally further includes an animated sequence of a popular cartoon character performing a skit. The text descriptor 538 includes relevant words to accompany the symbolic descriptor 534. In another embodiment, however, the text descriptor 538 may be animated in addition to the symbolic descriptor 534. For instance, in an embodiment, the text descriptor 538 may move around on the transition screen 530 according to the animated sequence comprising the symbolic descriptor 534.

In some embodiments, the letters comprising the text descriptor 538 may change size, shape, color, order, orientation, or other similar attributes, according to the animation comprising the symbolic descriptor 534. An animated cartoon character and animated text maintain the interest of children during an otherwise boring period during which the computing system 500 performs a background operation. The transition screens 530 are shown in conjunction with a program that has a buzzing feature for incorrect answers and a ringing bell feature for correct answers. The symbolic descriptor 534 further displays an animated character relating the possible answers, and the text descriptor 538 further displays at least one flashing noun (e.g., an electronic flash card) relating to the query, while playful music is sounded by the loudspeakers of the computing device 104.

FIG. 6 illustrates a screen displayed in response to a user's answer to the query of FIG. 5, according to one embodiment. The text descriptor 638 includes a description of the user's answer, such as YES or NO to a query, such as the binary question (e.g., Q: Are fish mammals?) shown in FIG. 5. The text descriptor 638 further includes optional text, for example, correct or incorrect, indicating whether the appropriate response to the binary question prompting a yes or a no answer (e.g., A: YES or NO) has been made. The symbolic descriptor 634 includes an image of the object, such as an image of a fish, and an image relating to remaining portions of the query, corresponding to the query that conveys visual information to the end-user (e.g., a child). The symbolic descriptor 634 is used for further reinforcing recognition and understanding of the object (fish) of the query, for example, the written word and the audible word, in relation to remaining portions (mammals) of the query.

The computing system 600 is intended for children of a specific age group. The computing system 600 includes a touch screen display 616 that is configured to display a response screen 630 that includes a symbolic descriptor 634 and a text descriptor 638. The symbolic descriptor 634 optionally further includes an animated sequence of a popular cartoon character performing a skit. The text descriptor 638 includes relevant words to accompany the symbolic descriptor 634. In another embodiment, the text descriptor 638 may be animated in addition to the symbolic descriptor 634. For instance, in an embodiment, the text descriptor 638 may move around on the transition screen 630 according to the animated sequence including the symbolic descriptor 634.

In some embodiments, the letters comprising the text descriptor 638 may change size, shape, color, order, orientation, or other similar attributes, according to the animation including the symbolic descriptor 634. An animated cartoon character and animated text maintain the interest of children during an otherwise boring period during which the computing system 600 performs a background operation. The transition screens 630 may be used with a program that has a buzzing feature for incorrect answers and a ringing bell feature for correct answers. The symbolic descriptor 634 further displays an animated character relating the possible answers, and the text descriptor 638 further displays at least one flashing noun (e.g., an electronic flash card) relating to the query, while playful music is sounded by the loudspeakers of the computing device 104.

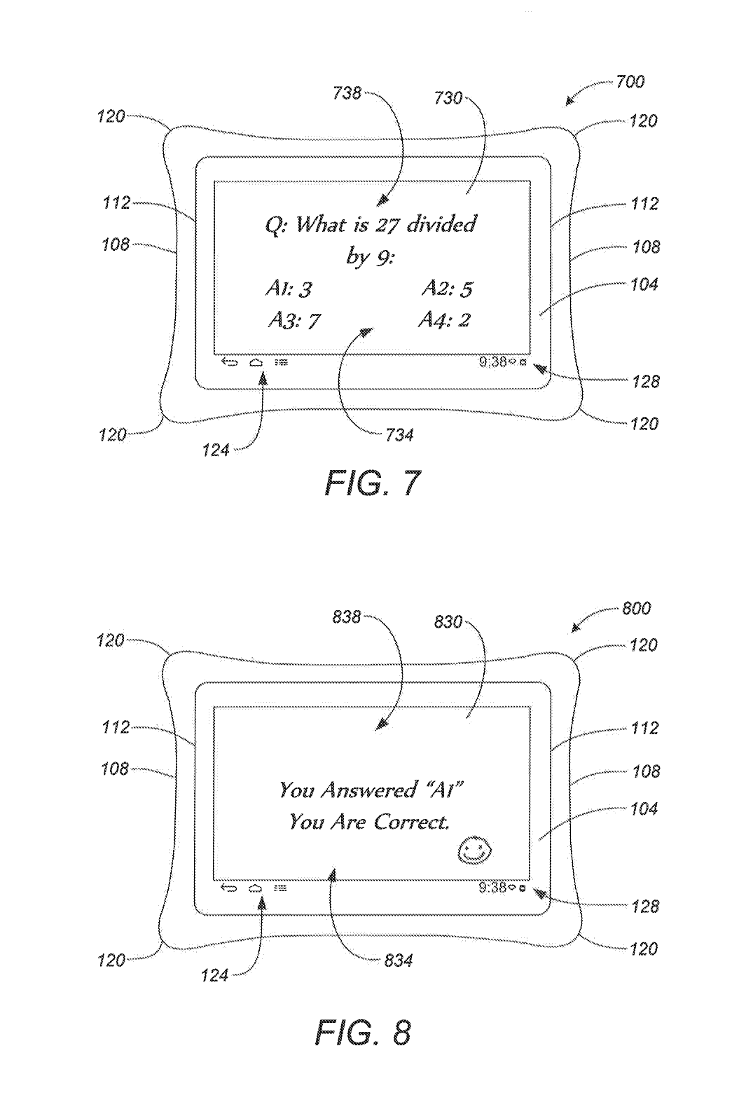

FIG. 7 illustrates another exemplary query screen displayed on a display of a computing device, according to one embodiment. The text descriptor 738 includes a query of a multiple-choice question (e.g., Q: What is 27 divided by 9:), and optional text indicating that an appropriate response to the multiple-choice question is A1-A4. The symbolic descriptor 734 may include an image of the object related to the question (e.g., 27 apples and 9 boxes) and/or an image that relates to remaining portions of the query to convey visual information to the end-user (e.g., a child) for reinforcing recognition and understanding of the nature of the query (e.g., numbers). The query screen may be provided to the end-user in the form of the written word augmented with a narration, in relation to remaining portions of the query.

According to one embodiment, the computing system 700 is intended for children of a specific age group. The touch screen display 716 displays a transition screen 730 including the symbolic descriptor 734 and the text descriptor 738. The symbolic descriptor 734 may further show an animated sequence of a popular cartoon character performing a skit. The text descriptor 738 includes relevant words to accompany the symbolic descriptor 734. In another embodiment, the text descriptor 738 may be animated in addition to the symbolic descriptor 734. For instance, the text descriptor 738 may move around on the transition screen 730 according to the animated sequence including the symbolic descriptor 734.

In some embodiments, the letters of the text descriptor 738 may change size, shape, color, order, orientation, or other similar attributes, according to the animation including the symbolic descriptor 734. An animated cartoon character and animated text maintain the interest of children during an otherwise boring period during which the computing system 700 performs a background operation. Moreover, the transition screens 730 are not limited to conveying information about a background operation of the computing device 104. The transition screen 730 may be used with a program that has a buzzing feature for incorrect answers and a ringing bell feature for correct answers. The symbolic descriptor 734 further displays an animated character relating the possible answers, and the text descriptor 738 further displays at least one flashing noun (e.g., an electronic flash card) relating to the query, while playful music is sounded by the loudspeakers of the computing device 104.

FIG. 8 illustrates a screen displayed in response to a user's answer to the query of FIG. 7, according to one embodiment. The text descriptor 838 includes a description of the user's answer (e.g., A1) to the multiple-choice question (e.g., What is 27 divided by 9:) shown in FIG. 7. The text descriptor 838 further includes optional text, for example, correct or incorrect, indicating whether the appropriate response to the multiple-choice question prompting that an appropriate answer (e.g., A1-A4) has been made. The symbolic descriptor 834 includes an image of the object (e.g., animated number, 9 apples in each of the 3 boxes), or an image relating to remaining portions of the query, corresponding to the query that conveys visual information to the end-user (e.g., a child). The symbolic descriptor 834 is used for further reinforcing recognition and understanding of the object (number) of the query, for example, the written word and the audible word, in relation to remaining portions of the query.

The computing system 800 is intended for children of a specific age group. The computing system 800 includes a touch screen display that is configured to display a response screen 830 that includes a symbolic descriptor 834 and a text descriptor 838. The symbolic descriptor 834 optionally further includes an animated sequence of a popular cartoon character performing a skit. The text descriptor 838 includes relevant words to accompany the symbolic descriptor 834. In another embodiment, the text descriptor 838 may be animated in addition to the symbolic descriptor 834. For instance, in an embodiment, the text descriptor 838 may move around on the transition screen 830 according to the animated sequence including the symbolic descriptor 834.

In some embodiments, the letters comprising the text descriptor 838 may change size, shape, color, order, orientation, or other similar attributes, according to the animation including the symbolic descriptor 834. An animated cartoon character and animated text maintain the interest of children during an otherwise boring period during which the computing system 800 performs a background operation. The transition screens 830 may be used with a program that has a buzzing feature for incorrect answers and a ringing bell feature for correct answers. The symbolic descriptor 834 further displays an animated character that relates to a possible answer, and the text descriptor 838 further displays at least one flashing noun (e.g., an electronic flash card) relating to the query, while playful music is sounded by the loudspeakers of the computing device 104.

Referring to FIGS. 1-8, the display screens including a symbolic descriptor and a text descriptor are compatible with at least one of a computing device and a computing system. An audio query associated with any of the display screens shown in FIGS. 1-8 may relate to a binary question or a multiple-choice question. The audio query may be directed to educational content including, but not limited to, learning material for children. A set of executable instructions executed by a processor of the computing device 104 includes a feature for processing a vocal signal and a feature for categorizing the vocal signal. The computing device 104 may be a tablet computer, according to one embodiment, and the computing system may include a tablet computer including a protector (e.g., 108 of FIG. 1).

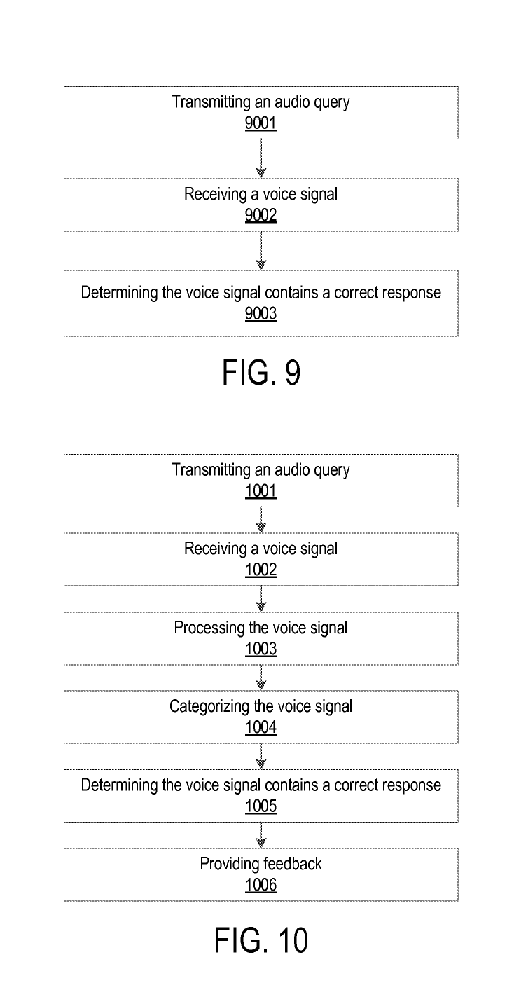

FIG. 9 is a flowchart for providing an audio interface, according to one embodiment. An audio interface is provided with a speaker and a microphone that is adapted to communicate with a processor of a tablet computer. In one embodiment, the processor runs an application installed on the tablet computer to provide the audio interface. An example of the application is an educational game targeted for children or a specific age group. An audio query is transmitted to a user via the speaker of the tablet computer (9001). The application has a voice recognition feature adapted to communicate with the processor, and receive a vocal signal from the user in response to the audio query (9002). The processor is operable by a set of executable instructions storable in a non-transitory medium of the tablet computer. The application determines whether the vocal signal contains a correct response to the audio query (9003).

FIG. 10 is a flowchart for providing an audio interface, according to another embodiment. An application running on a tablet computer provides audio interface to a user. The audio interface is provided to the user by transmitting an audio query transmitted to the user (1001) and receiving a voice signal in response to the audio query (1002). The application further processes the vocal signal using a voice recognition feature (1003). The voice recognition feature extracts a response to the audio query from the user within a predetermined time. After the predetermined time expires, the application asks the user if he/she needs more time to respond or prompts the user to provide a response or move onto another audio query. The application further categorizes the vocal signal (1004). The categorization feature determines whether the voice signal contains a proper answer or an accurate answer to the audio query. For example, an improper answer is an answer other than the given choices of a multiple-choice query, or an answer other than YES or NO in a binary query. An accurate answer is a proper answer and the answer that is a correct response to the audio query. Based on the processing and categorization of the received voice signal, the application determines whether the vocal signal is correct in relation to the query (1005). The application provides visual and audible feedback in relation to correctness of the vocal signal (1006). The feedback may include a real-time feedback to the user providing a hint for a correct answer or a comment to the response from the user. In another embodiment, the application sends a notification, message, or an email to a supervisory user (e.g., a parent) to inform how the user (e.g., a child) associated with the supervisory user performs with the queries.

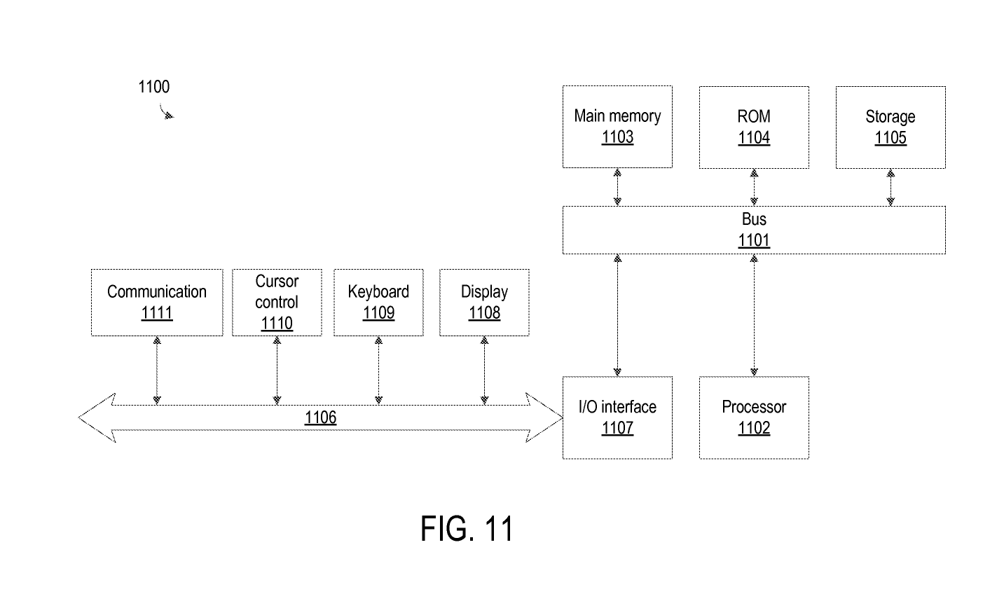

FIG. 11 illustrates an exemplary computer architecture that may be used for the present system, according to one embodiment. The exemplary computer architecture may be used for implementing one or more components described in the present disclosure including, but not limited to, the present content curation system. One embodiment of architecture 1100 includes a system bus 1101 for communicating information, and a processor 1102 coupled to bus 1101 for processing information. Architecture 1100 further includes a random access memory (RAM) or other dynamic storage device 1103 (referred to herein as main memory), coupled to bus 1101 for storing information and instructions to be executed by processor 1102. Main memory 1103 also may be used for storing temporary variables or other intermediate information during execution of instructions by processor 1102. Architecture 1100 may also include a read only memory (ROM) and/or other static storage device 1104 coupled to bus 1101 for storing static information and instructions used by processor 1102.

A data storage device 1105 such as a magnetic disk or optical disc and its corresponding drive may also be coupled to architecture 1100 for storing information and instructions. Architecture 1100 can also be coupled to a second I/O bus 1106 via an I/O interface 1107. A plurality of I/O devices may be coupled to I/O bus 1106, including a display device 1108, an input device (e.g., an alphanumeric input device 1109 and/or a cursor control device 1110).

The communication device 1111 allows for access to other computers (e.g., servers or clients) via a network. The communication device 1111 may include one or more modems, network interface cards, wireless network interfaces or other interface devices, such as those used for coupling to Ethernet, token ring, or other types of networks.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter can have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims. The various embodiments described above are provided by way of illustration only and should not be construed to limit the scope of the disclosure. Those skilled in the art will readily recognize various modifications and changes that can be made to the principles described herein without following the example embodiments and applications illustrated and described herein, and without departing from the spirit and scope of the disclosure.

What is claimed is:

1. An apparatus comprising:
a processor adapted to run an operating system in multi-operating environments including a first operating environment for a first user and a second operating environment for a second user, wherein the operating system runs in the first operating environment by default and switches from the first operating environment to the second operating environment in response to an authorized input from the second user;
a voice output module adapted to communicate with the processor and transmit an audio query appropriate for the first user according to an application program running in the first operating environment;
a voice input module adapted to receive a vocal signal in response to the audio query; and
a display adapted to display a content item associated with the audio query,
wherein the application program is further configured to determine whether the vocal signal contains a correct response to the audio query, and
wherein the application program is configured to run in the first operating environment while the operating system performs a background operation.

2. The apparatus of claim 1, wherein the apparatus is a tablet computer.

3. The apparatus of claim 1, wherein the audio query comprises a binary question or a multiple-choice question.

4. The apparatus of claim 1, wherein the audio query contains educational content for the first group of user.

5. The apparatus of claim 1, wherein the application program categorizes the voice signal to determine that the vocal signal contains the correct response.

6. The apparatus of claim 1, wherein the content item displayed on the display comprises transition screens.

7. The apparatus of claim 6, wherein the transitional screens comprise a symbolic descriptor and a text descriptor associated with the audio query.

8. The apparatus of claim 6, wherein the transitional screens are display on the display at one or more predetermined times and for a predetermined duration to entertain or interest the user while the operating system performs the background operation or during an idle time of a second application program running in the first operating environment.

9. The apparatus of claim 6, wherein the transitional screens contain a logo, an image of a popular sports personality, a picture of a movie star, a cartoon character, or an image suitable for displaying on the display.

10. The apparatus of claim 1, wherein the application program provides audible feedback in relation to the vocal signal.

11. A method comprising:
running an operating system of a computer system in multi-operating environment including a first operating environment for a first user and a second operating environment for a second user, wherein the operating system runs in the first operating environment by default and switches from the first operating environment to the second operating environment in response to an authorized input from a supervisory user;
selecting an audio query appropriate for the first user according to an application program running in the first operating environment;
transmitting the audio query according to the application program via a voice output module of the computer system;
displaying a content item associated with the audio query on a display of the computing system;
receiving a vocal signal in response to the audio query using a voice input module of the computer system; and
determining whether the vocal signal contains a correct response to the audio query,
wherein the application program is configured to run in the first operating environment while the operating system performs a background operation.

12. The method of claim 11, wherein the audio query comprises a binary question or a multiple-choice question.

13. The method of claim 11, wherein the audio query contains educational content for the first user.

14. The method of claim 11, further comprising categorizing the voice signal to determine that the vocal signal contains the correct response.

15. The method of claim 11, further comprising providing feedback in relation to the vocal signal.

16. The method of claim 11, further comprising dictating the audio query via the audio output module of the computer system.

17. The method of claim 11, further comprising displaying transition screens.

18. The method of claim 17, wherein the transitional screens comprise a symbolic descriptor and a text descriptor.

19. The method of claim 17, further comprising displaying the transitional screens at one or more predetermined times and for a predetermined duration to entertain or interest the while the operating system performs the background operation or during an idle time of a second application program running in the first operating environment.

20. The method of claim 17, wherein the transitional screens contain a logo, an image of a popular sports personality, a picture of a movie star, a cartoon character, or an image suitable for displaying on the display.
